(19) United States
(12) Patent Application Publication
(10) Pub. No.: US 2004/0035842 A1
(43) Pub. Date: Feb. 26, 2004

(54) Electrically heating cable and its application

(76) Inventors: Chung-Chi Cheng, Taichung (TW); Wen-Chang Shin, Beituen Chiu (TW); Maxwell Hsu, Jungli City (TW)

Correspondence Address: BIRCH STEWART KOLASCH & BIRCH, PO BOX 747, FALLS CHURCH, VA, 22040-0747, US

(21) Appl. No.: 10/225,498

(22) Filed: Aug. 22, 2002

(51) Int. Cl. H05B 3/36

(52) U.S. Cl. 219/212; 219/544; 219/549

(57) ABSTRACT

An electrically heating cable of the invention comprises a central core formed from the assembly of a plurality of graphite fibers. The central core is covered with a nylon layer. Around the nylon layer is wound a temperature sensing wire made of nickel in a helicoid manner. Ultimately, the electrically heating cable is encapsulated within an insulating layer made of polyvinyl chloride. Thereby, the electrically heating cable is provided with a sufficient toughness and flexibility to prevent cracks and ensure a safe use.

### FIELD OF THE INVENTION

The invention relates to a structure of an electrically heating cable. More particularly, the invention provides an electrically heating cable that is comprised of a central core formed from graphite fibers that are not subjected to thermal fatigue and is further provided with a sufficient resistance to thermal expansion so as to prevent defective cracks. The electrically heating cable can be thereby applied within various types of heating appliances such as electrical blankets and heating pad devices.

### BACKGROUND OF THE INVENTION

Referring to FIG. 1, a schematic view illustrates an electrically heating cable of the prior art. The traditional heating cable principally comprises a central core 1 formed from a plurality of glass fibers. Around the core 1 is further wound a copper-nickel (or copper-chromium) wire 2 in a helicoid manner. Thereon is subsequently covered a nylon layer 3. Around the nylon layer 3 is wound a temperature sensing wire 4 made of nickel. Ultimately, the entire cable 10 is encapsulated within an insulating layer 5 made of polyvinyl chloride. Two terminals of the copper-nickel (or copper chromium) wire 2, winding the core 1, are electrically connected to a power source, thereby achieving a traditional electrically heating cable. With the above structure, a flow of electrical current through the wire 2 generates a heating thereof. However, at a high temperature, the wire 2 easily extends, which reduces its resistance to tug tension. When the temperature decreases, the wire 2 recovers its initial shape. As a result, the wire 2 is easily subjected to thermal fatigues and may easily breaks. Therefore, heating appliances provided with the above heating cable of the prior art are often subjected to fatigue deficiency or cracks due to tug tension or pressure action applied thereon.

### SUMMARY OF THE INVENTION

It is therefore an object of the invention to provide an electrically heating cable which resistance to tug tension is not reduced with an increase in temperature so that a safe and durable use thereof can be obtained.

It is another object of the invention to provide an electrically heating cable that rapidly heats so that power consumption can be reduced.

To accomplish the above and other objectives, an electrically heating cable of the invention comprises a central core formed from the assembly of a plurality of graphite fibers. The central core is covered with a nylon layer. Around the nylon layer is wound a temperature sensing wire made of nickel in a helicoid manner. Ultimately, the electrically heating cable is encapsulated within an insulating layer.

According to an embodiment of the invention, the above electrically heating cable is mounted in an electrical blanket. The electrical blanket comprises a blanket body that is double-layered woven. The blanket body is internally provided with a plurality of cavities formed in a S-profiled contour through which is disposed the electrically heating cable. As described above, the electrically heating cable is comprised of at least a central core formed from the assembly of a plurality of graphite fibers.

According to another embodiment of the invention, the above electrically heating cable is mounted within a heating pad device. The heating pad device comprises a heating layer, an encapsulating body and a heating pad. A surface of the heating layer is provided with an electrically heating cable wound in a looped manner, the electrically heating cable being comprised of a central core (11) formed from a plurality of graphite fibers. Each bend of the wound cable is fixed to the heating layer via the pressure of a lead slice. The encapsulating body is externally slipped on the heating layer and is further provided with a plurality of infrared ray devices thereon. The heating pad encapsulating the heating pad device is formed in a pocket shape and is capable of absorbing moisture.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a perspective view of an electrically heating cable of the prior art;

FIG. 2 is a perspective view of an electrically heating cable according to an embodiment of the invention;

FIG. 3 is a cross-sectional view of the cable of FIG. 2 according to an embodiment of the invention;

FIG. 4 is a schematic view showing an application of an electrically heating cable of the invention in an electrical blanket according to an embodiment of the invention;

FIG. 5 is a planar view of an electrical blanket provided with an electrically heating cable according to an embodiment of the invention;

FIG. 6 is a perspective view showing an application of an electrically heating cable of the invention in a heating pad device according to an embodiment of the invention; and

FIG. 7 is a cross-sectional view of FIG. 6.

### DETAILED DESCRIPTION OF THE EMBODIMENTS

Wherever possible in the following description, like reference numerals will refer to like elements and parts unless otherwise illustrated.

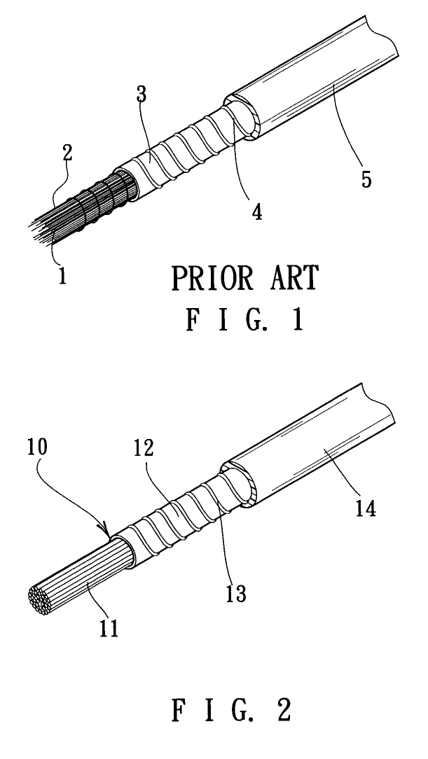

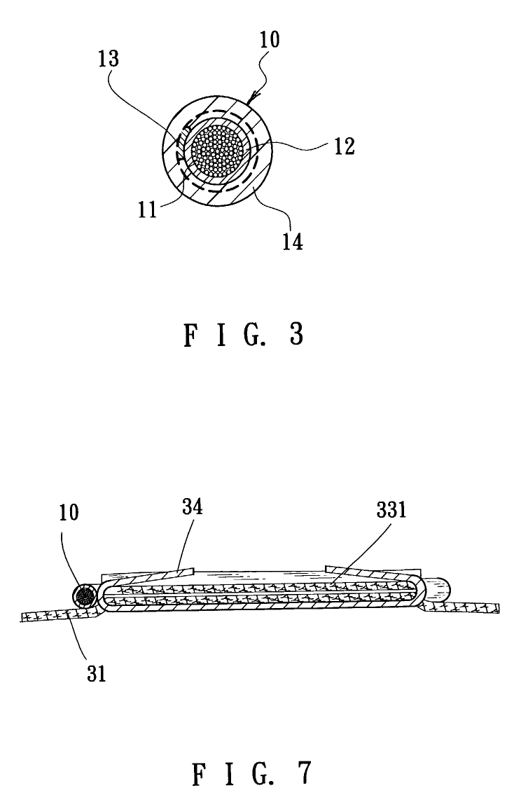

Referring to FIG. 2 and FIG. 3, an electrically heating cable 10 of the invention comprises a heating central core 11 that is formed by the assembly of a plurality of graphite fibers. A periphery of the central core 11 is covered with a nylon layer 12. Around the nylon layer 12 is wound a helicoid temperature sensing wire 13 made of nickel. Ultimately, the cable 10 is externally covered with an insulating layer 14 made of polyvinyl chloride. The temperature sensing wire 13 is further connected to a temperature control switch (not shown) to control the temperature of the cable 10 within a predetermined range.

When electrical power is supplied to the above cable 10, the core 11 heats. Because the graphite fibers have a substantial toughness, the length of the core 11 thus does not expand with an increase of the temperature, which may negatively cause a reduction of its resistance to tug tension. Moreover, when the temperature decreases, fatigue effects are also prevented. Furthermore, by means of the nylon layer 12, the resistance of the core 11 to heating pressure and expansion are reinforced. Hence, with a substantial toughness of the core 11, safety and better service life of the cable 10 are obtained. In addition, the graphite fibers of the core 11 prevent fatigues and nonuniform heating of the traditional core 1 under thermal stress. Indeed, the traditional core 1, commonly made of glass fibers and wound with a thermally conductive wire 2 of nickel-chromium, is subjected to a nonuniform density distribution of the winding of the wire 2 under thermal stress, which causes a nonuniform heating of the entire cable. Therefore, if the electrically heating cable 10 of the invention is used in heating appliances such as heating pad devices or electrical blankets, inadvertent breaking of the cable caused. by the user is prevented. More particularly when it is used in, for example, a flexible spring mattress, the electrically heating cable 10, by its flexibility and toughness, does not hurt the user's feet and knees when he/she kneels on the mattress and is further prevented from breaking. A safe and durable use of the mattress is thereby obtained.

It should be noted that because the graphite fibers of the core 11 are formed by graphitizing carbonic elements within an inert environment at high temperature, the crystalline structure thereof is therefore directionally oriented with a substantial uniformity. Furthermore, the resistance of the graphite fibers is very stable. At high thermal stress caused by a high temperature difference, the core 11 thus is not subjected to expansion or contraction, thermal fatigues' which may lead to cracks are therefore prevented. Moreover, by means of the nylon layer 12 and the insulating layer 14 of polyvinyl chloride, the electrically heating cable 10 is provided with a better resistance to extension, folding, and pressure. Since the graphite fibers are further provided with a substantially good thermal conductivity characteristic, the desired temperature of heating is attained rapidly, power consumption can be therefore reduced.

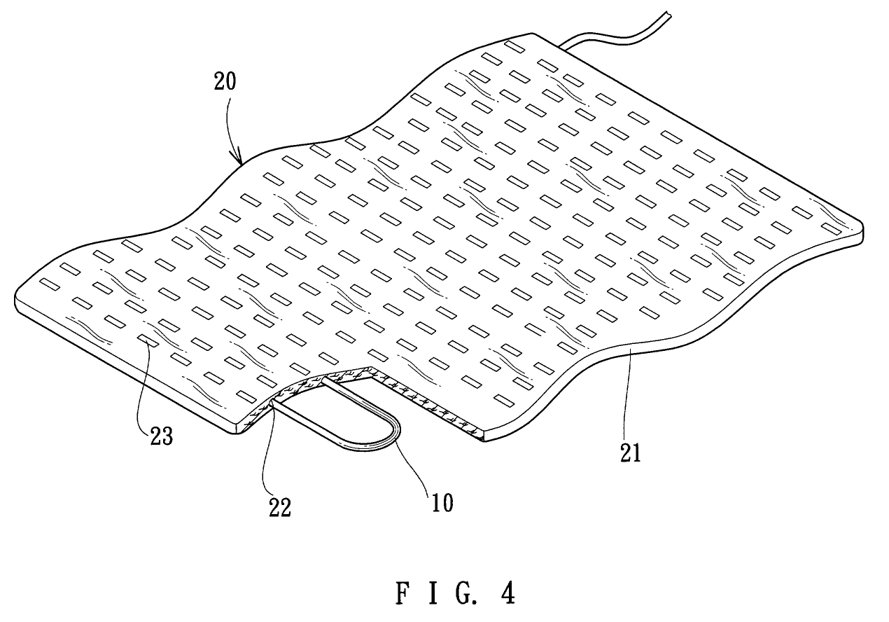

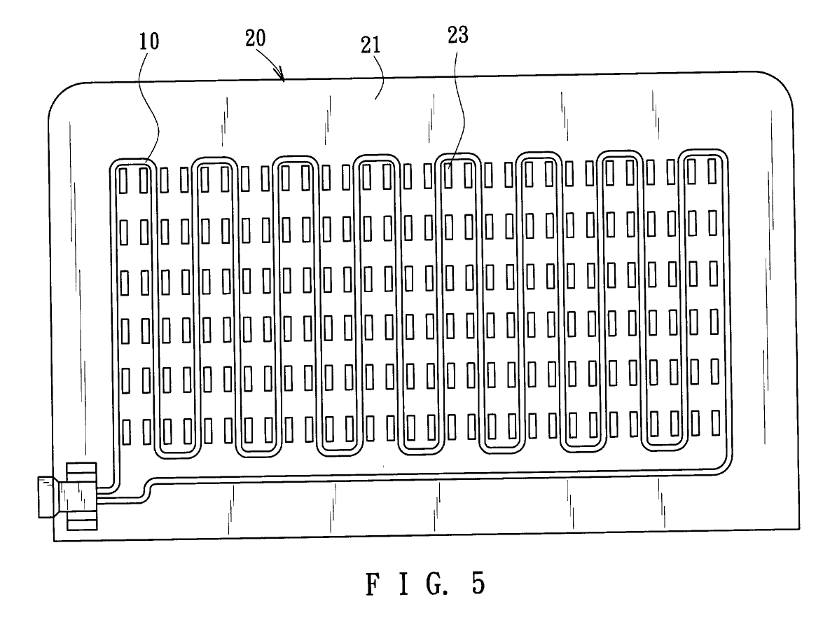

A first example of application of the electrically heating cable as described above now is illustrated with reference to FIG. 4 and FIG. 5. FIG. 4 and FIG. 5 are schematic views illustrating the mount of the electrically heating cable 10 in an electrical blanket 20. The blanket 20 is comprised of a blanket body 21 that is double-layered and formed from a mix of acrylic and polyester fibers. The blanket body 21 is internally provided with cavities 22 extended in S-profiled contour through which the electrically heating cable 10 is disposed. The electrically heating cable 10 is thereby fixedly mounted in the blanket body 21. The blanket body 21 is formed via weaving both layers thereof with a spacing width, an assembly portion 23 is thereby formed. Thereafter, each layer is respectively woven so as to form the cavities 22 where the electrically heating cable 10 is arranged. Two adjacent portions of the cable 10 placed in the cavities 22 are thereby strictly separated from each other. Messy tangles of the cable 10 within the blanket 20 are therefore prevented.

Since the core 11 of the cable 10 provided within the blanket 20 does not suffer from thermal contraction/expansion under thermal stress and thermal fatigues are reduced, damages of the cable 10 due to a pressure action on the blanket 20 are therefore prevented.

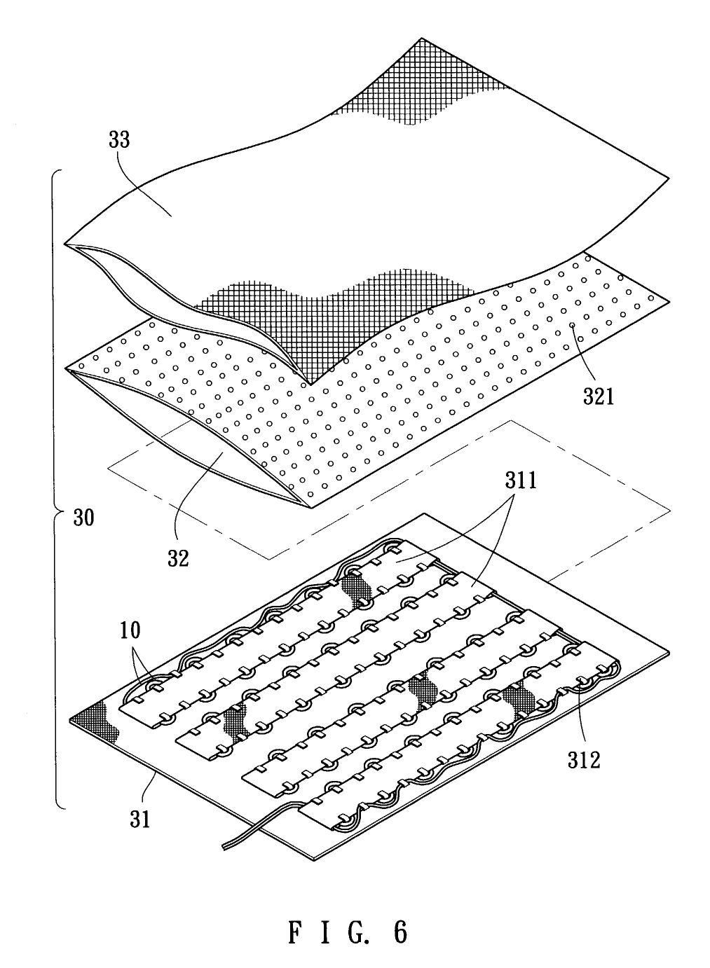

Referring now to FIG. 6, a second example of application of the invention is the mount of the cable 10 in a heating pad device 30. As illustrated, the heating pad device 30 principally comprises a cotton-based heating layer 31, an infrared encapsulating body 32, and a moisture-content heating pad 33. On a face of the heating layer 31 is wound the electrically heating cable 10 in a S-profiled contour. On each row of wound cable 10 is covered an encapsulating strip 311. Each encapsulating strip 311 is fixed via the pressure of a lead slice 312 that has two opposite end portions fixed on another face of the heating layer 31, as shown in FIG. 7.

An external face of the heating pad device 30 is further covered with an infrared encapsulating body 32. Furthermore, a moisture-content heating pad 33 formed in pocket shape slips on an outer side of the infrared encapsulating body 32.

When electrical power is supplied, the heat, irradiated from the cable 10 on the surface of the heating layer 31, is conducted to each lead slice 312 to be accumulated. By means of a substantial weight of the lead slices 312, the entire heating pad device 30 is therefore sufficiently pressed on the user's body. Heat can be thereby effectively conducted to the portion of the user's body to be cured. Via infrared ray devices 321 distributed on the surface of the encapsulating body 32, the curing effectiveness is further increased. Moreover, via the external mount of the moisture-content heating pad 33, air moisture can be absorbed and transformed into vapor via the heat irradiated from the heating layer 31. An adequate hot compress effect can be therefore provided.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An electrically heating cable, comprising at least a central core formed from the assembly of a plurality of graphite fibers, the central core being covered with a nylon layer , the nylon layer being further provided with a temperature sensing wire made of nickel and wound in helicoid manner there around, the electrically heating cable being externally covered with an insulating layer.

2. An electrical blanket, principally comprising a double-layered woven blanket body and at least an electrically heating cable, the blanket body being provided with a plurality of cavities formed in a S-profiled contour to receive the electrically heating cable therein, the electrical blanket being characterized in that the electrically heating cable is comprised of at least a central core that is formed from the assembly of a plurality of graphite fibers.

3. A heating pad device, comprising a heating layer, an encapsulating body and a heating pad, a surface of the heating layer being provided with an electrically heating cable wound in a looped manner, the electrically heating cable being comprised of a central core formed from a plurality of graphite fibers, wherein each bend of the wound cable is fixed to the heating layer via the pressure of a lead slice, the encapsulating body is externally slipped on the heating layer and is further provided with a plurality of infrared ray devices thereon, and the heating pad encapsulating the heating pad device is formed in a pocket shape and is capable of absorbing moisture.
